(19) United States
(12) Patent Application Publication
(10) Pub. No.: US 2009/0020601 A1
(43) Pub. Date: Jan. 22, 2009

(54) Systems and Methods for Displaying, Storing, and Providing Information Regarding Objects

(75) Inventors: Brian Woodbury, Gilbert, AZ (US); John Spenik, Phoenix, AZ (US); Roc Lastinger, Cave Creek, AZ (US)

Correspondence Address: LETHAM LAW FIRM, LLC, 914 N. TUCANA LANE, GILBERT, AZ, 85234, US

(73) Assignee: Quixcode, LLC, Scottsdale, AZ (US)

(21) Appl. No.: 12/199,432

(22) Filed: Aug. 27, 2008

Related U.S. Application Data
(63) Continuation-in-part of application No. 12/027,235, filed on Feb. 6, 2008.
(60) Provisional application No. 60/900,143, filed on Feb. 8, 2007.
(60) Provisional application No. 60/905,522, filed on Mar. 7, 2007.
(60) Provisional application No. 60/943,098, filed on Jun. 11, 2007.
(60) Provisional application No. 60/968,400, filed on Aug. 28, 2007.
(60) Provisional application No. 61/019,127, filed on Jan. 4, 2008.

(51) Int. Cl. G06K 7/00; G06F 17/00

(52) U.S. Cl. 235/375; 235/439

(57) ABSTRACT

Systems and methods for managing, displaying, and/or storing objects that include providing a carrier, using one or more tags to modulate the carrier to produce a modulated carrier, transmitting the modulated carrier to a reader through a conductor or Tirelessly. All tags are coupled to a first conductor.

### CROSS-REFERENCE TO RELATED APPLICATIONS

This application is a continuation-in-part under 35 U.S.C. § 120 of U.S. application Ser. No. 12/027,235 file Feb. 6, 2008 which claims the benefit under 35 U.S.C. § 119(e) of U.S. Provisional Application No. 60/900,143 filed Feb. 8, 2007, U.S. Provisional Application No. 60/905,522 filed Mar. 7, 2007, U.S. Provisional Application No. 60/943,098 filed Jun. 11, 2007, U.S. Provisional Application No. 60/968,400 filed Aug. 28, 2007, and U.S. Provisional Application No. 61/019,127 filed Jan. 4, 2008. All above applications are herein incorporated by reference.

### FIELD OF THE INVENTION

Embodiments of the present invention relate to systems and methods for identifying, tracking, monitoring, displaying, storing, and/or providing information regarding objects and methods for performing operations in accordance with identifying, tracking, monitoring, displaying, storing, and/or providing information regarding objects.

### BACKGROUND OF THE INVENTION

Convention systems for identifying, tracking, and/or monitoring objects (e.g., RFID, barcode) generally employ a bidirectional communication between a reader and the object. Bidirectional communication permits a reader to individually address (e.g., select) and communicate with a single object. Bidirectional communication increases cost and complexity of a system. Furthermore, conventional wireless systems perform poorly when attempting to communicate with the objects in close physical proximity. A system that uses one-way communication from a plurality of objects to a reader and improves identification of objects in close physical proximity may benefit from decreased cost and increased reliability of performance. Furthermore, retailers, security officers, and inventory controllers may benefit from a system that displays objects and/or stores objects while providing information (e.g., on-demand, real-time) regarding the objects.

### SUMMARY OF THE INVENTION

According to various aspects of the present invention, a tag mechanically couples to an object. The tag stores an information regarding the object to which it is mechanically mounted. A tag or a plurality of tags, mechanically coupled to respective objects, electrically couple to a first conductor. In an embodiment, a carrier generator provides a carrier to each tag. The modulated signal provides indicia of the information stored by the tag regarding the object. A reader receives the modulated signal from each tag thereby receiving the indicia of information from each tag. The communication between one tag or a plurality of tags and the reader is unidirectional in that the reader receives indicia of information from one or more tags, but does not send information, data, control signals, and/or power to any tag. In another embodiment, a reader communicates bidirectionally with each tag to receive indicia of information from one or more tags.

The systems and methods, according to various aspects of the present invention, display and/or store an object and/or a plurality of objects while simultaneously providing a conduit for communication (e.g., transmission and/or reception) of information regarding each object respectively.

### BRIEF DESCRIPTION OF THE DRAWING

Embodiments of the present invention will now be further described with reference to the drawing, wherein like designations denote like elements, and:

FIG. 1 is a functional block diagram of a system, according to various aspects of the present invention, having a reader that receives through a conductor;

FIG. 2 is a functional block diagram of a system, according to various aspects of the present invention, having a reader that receives an RF signal radiated by a conductor;

FIG. 3 is a functional block diagram of a system, according to various aspects of the present invention, that provides a carrier wirelessly and has a reader that receives an RF signal radiated by a conductor;

FIG. 4 is a functional block diagram of a system, according to various aspects of the present invention, having a reader that receives an RF signal radiated by a plurality of tags that have a common source of power;

FIG. 5 a plan view of the system of FIGS. 1-4 in an implementation for a filing system;

FIG. 6 a top plan view of the system of FIG. 5;

FIG. 7 a close-up plan view of a rail and a hook of system of FIG. 5;

FIG. 8 a schematic diagram of a directional device for the systems of FIGS. 1-4;

FIG. 9 a schematic diagram of a directional device for the systems of FIGS. 1-4;

FIG. 10 a top plan view of a segmented rail for a the system of FIGS. 5-7;

FIG. 11 is a plan view of the system of FIGS. 1-4 implemented for a card system;

FIG. 12 is a plan view of keyed card for the card of system FIG. 11;

FIG. 13 is a perspective plan view of a peg board for the system of FIG. 16;

FIG. 14 is a side plan view of a peg board for the system of FIG. 16;

FIG. 15 is a side plan view of a hook for the system of FIG. 16;

FIG. 16 is a perspective plan view of the system of FIGS. 1-4 implemented for a peg board;

FIG. 17 is a perspective plan view of the system of FIGS. 1-4 implemented for a peg board;

FIG. 18 is a schematic of the system of FIGS. 1-4 implemented for a peg board;

FIG. 19 is a perspective plan view of a hook of FIG. 20;

FIG. 20 is a plan view of the system of FIGS. 1-4 implemented for a peg board;

FIG. 21 is a perspective plan view of the system of FIGS. 1-4 implemented for a retrofit kit;

FIG. 22 is a cross-section view of the system of FIG. 21;

FIG. 23 is a top view of the system of FIGS. 21-22;

FIG. 24 is a top plan view of the system of FIG. 1 implemented for a retrofit kit;

FIG. 25 is a cross-sectional view of the system of FIG. 24;

FIG. 26 is a side plan view of the system of FIG. 21 implemented for shelf,

FIG. 27 is a top cross-sectional view of the system of FIG. 26;

FIG. 28 is a functional block diagram of a system, according to various aspects of the present invention, that provides a carrier wirelessly and has a reader that receives through a conductor;

FIG. 29 is a functional block diagram of a system, according to various aspects of the present invention, comprising a frame having two conductors, a plurality of supports each having two conductors, a plurality of tags each tag mechanically coupled to a respective object, and a reader having a carrier generator;

FIG. 30 is a functional block diagram of another system, according to various aspects of the present invention, comprising a frame having two conductors, a plurality of supports each having two conductors, a plurality of tags each tag mechanically coupled to a respective object, a carrier generator, and a reader;

FIG. 31 is a functional block diagram of a system, according to various aspects of the present invention, comprising a container having two conductors, a plurality of tags each tag mechanically coupled to a respective object, and a reader having a carrier generator;

FIG. 32 is a perspective plan view of a container of the system of FIG. 31 coupled to a frame of the systems of FIG. 29 or FIG. 30 wherein the frame is implemented as a peg board;

FIG. 33 is a perspective plan view of the system of FIGS. 11 and 12 that includes a container for displaying and/or storing the cards; and

FIG. 34 is a functional block diagram of a system, according to various aspects of the present invention, comprising a frame having two conductors, a plurality of supports each having two conductors, a plurality of tags each tag mechanically coupled to a respective object, and a reader having a receiver and a transmitter for bidirectional communication with the plurality of tags.

### DETAILED DESCRIPTION OF THE PREFERRED EMBODIMENTS

A system, according to various aspects of the present invention, identifies, tracks monitors, displays, stores and/or provides information regarding objects. A system may further perform a process in accordance with the identity of an object. A process may include compiling an inventory, accepting a shipment of objects, monitoring objects, dispensing objects, restocking objects, verifying receipt of a shipment of objects, dispensing objects according to an order, detecting unauthorized removal of an object, verifying authorized removal of an object, authenticating requests for removal of an object, displaying an object, selling an object, and tracking movement of an object.

A system, according to the various aspects of the present invention, may be used by, inter alia, retailers to display, sale, restock, and inventory items; a supply chain manager to track movement of an object between storage and transfer locations; an inventory controller for accepting, monitoring, dispensing, restocking, compiling an inventory, and verifying shipments received and/or dispensing according to order; a security officer for monitoring position, detecting unauthorized removal, verifying authorized removal, and authenticating requests for removal.

An object includes any tangible thing suitable for identifying, tracking, monitoring, displaying, storing, and/or describing using information. An object includes non-electronic documents (e.g., paper files, file folders, hanging files, envelops, red rope folders), promotional material (e.g., business card, brochure, paint chip), medical records (e.g., x-rays, charts, orders, prescriptions), goods (e.g., cigarettes, paint, sutures), process control material (e.g., paint chip, recipe, formula).

Identifying an object includes receiving information regarding an object, accessing information regarding objects in a database, and reporting information regarding an object. Information may include a unique identifier (e.g., unique number), object type, model, manufacturer, date of manufacture, description of an object, content of an object, a history of user access to the object, a use of the object, a permitted use of an object, operations performed to the object, operations performed with the object, operations performed by the object, a recipe, a formula, price, sales information, and markup.

Tracking includes providing an inventory of objects, counting a number of objects, identifying objects removed from an inventory, identifying objects added and/or returned to an inventory, cataloging properties of objects, identifying a physical location of an object, identifying movement of an object between locations, reporting an inventory, identifying a sale of an object, identifying a return of an object, and identifying detects of an item. Reporting an inventory includes reporting objects in an inventory, history of an inventory, and properties of each object.

Monitoring includes identifying and tracking objects over a period of time, noting changes to properties of an object, reporting information gathered from monitoring, and detecting circumstances (e.g., time, day, date) of removal of an object from a location.

Displaying an object may include positioning an object for display, positioning an object for observation, positioning an object for selection, providing a location for restocking an object, storing an object in a displayed position, supporting an object (e.g., hanging on hook, resting on shelf), mechanically coupling to an object or a plurality of objects to receive an information regarding each respective object, and providing a conduit (e.g., conductor, channel) for communicating of information regarding objects to a reader.

Positioning includes holding an object in a place and/or at an orientation. Supporting includes bearing at least a portion and/or all of the weight of an object.

Storing an object may include enclosing an object or a plurality of objects in a container, supporting an object (e.g., hanging on hook, resting on shelf), providing access to a container for dispensing enclosed objects from a container, providing access to a container for inserting an object or a plurality of objects into the container for holding, coupling to a system to receive information regarding each respective object enclosed in the container, and providing a conduit (e.g., conductor, channel) for communicating of information regarding objects to a reader.

A structure that displays and/or stores objects and provides information regarding the objects displayed and/or stored may facilitate identifying, tracking, and monitoring. A structure that display and/or stores may facilitate compiling a timely inventory, detecting theft of an object, detecting removal of an object from storage, providing notice that assistance is required (e.g., notice to sales people to assist a customer), verifying proper object placement (e.g., location, position) for display and/or storage, providing a notice that a stock of objects is completely or nearly completely consumed, and detecting restocking of an object.

A system may provide a report related to identifying, tracking, monitoring, displaying, and/or storing objects (e.g., missing objects, inventory, historical inventory, steps for performance of a process, removal, time on display, time in storage, history of movement, time, day, date). A system may provide information to and/or receive information from any source (e.g., human, computer, machine) using any conventional methods of communication (e.g., keyboard entry, wired, wireless, electronic bus) and any conventional protocols (e.g., modulation, demodulation, IEEE 802.11, Zigbee).

Information regarding an object may be stored in a record of a tag that is associated with the object. Information regarding an object may further be stored in a database. Information retrieved from a record in a tag may be used as an index into a database to acquire additional information regarding the object.

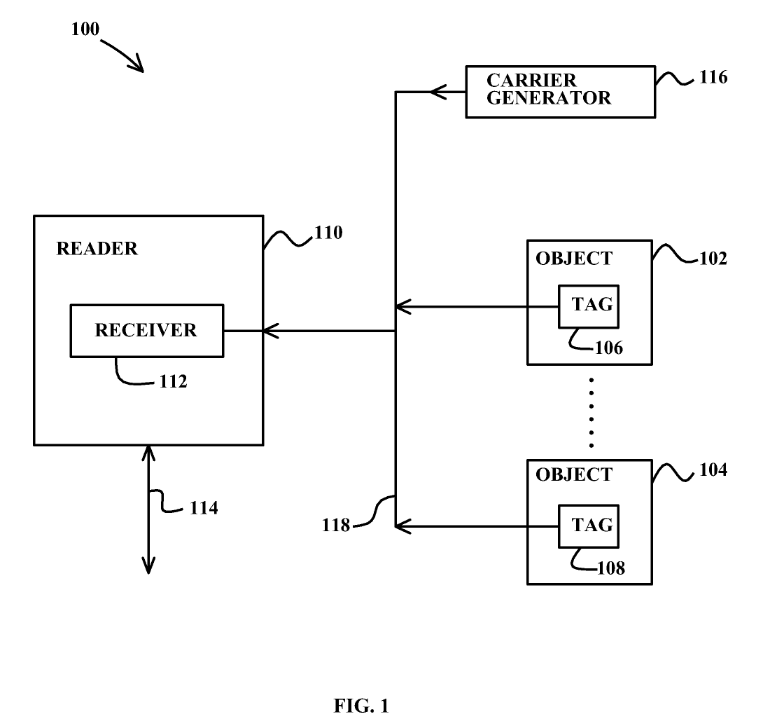

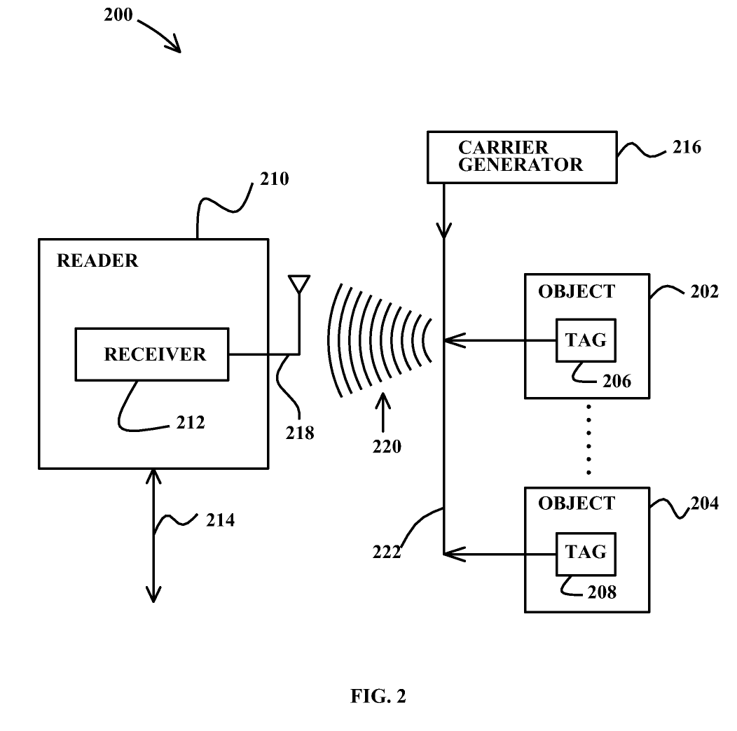

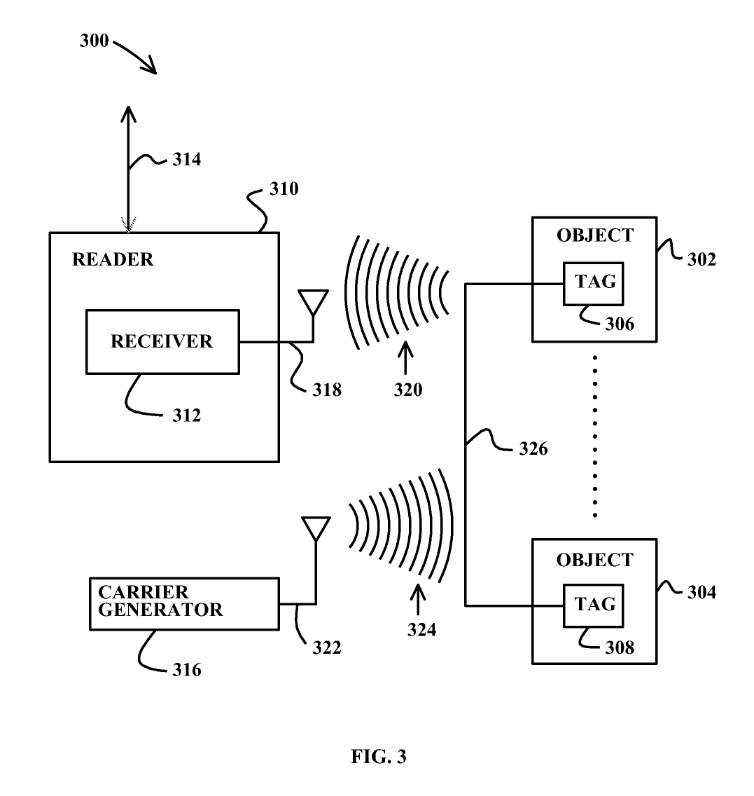

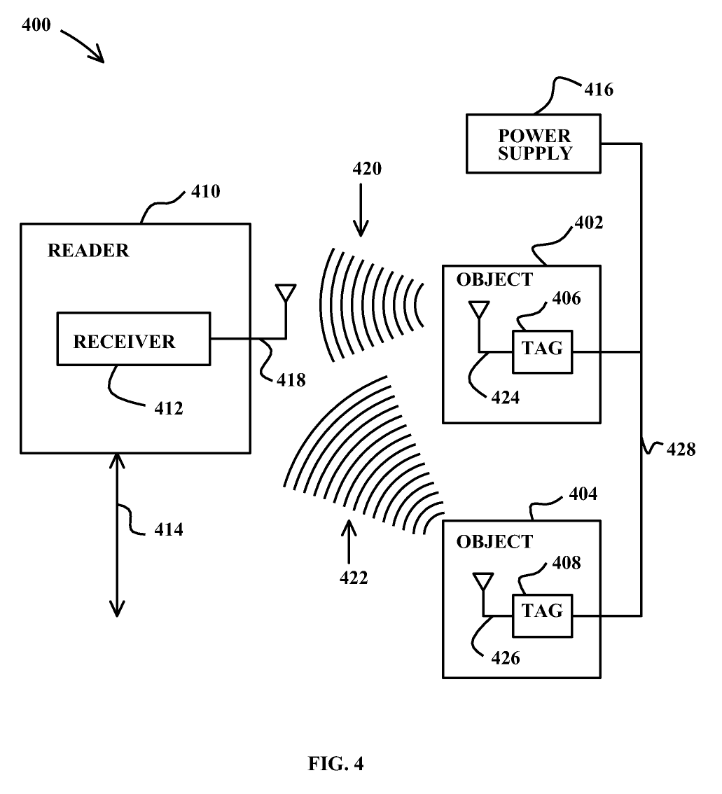

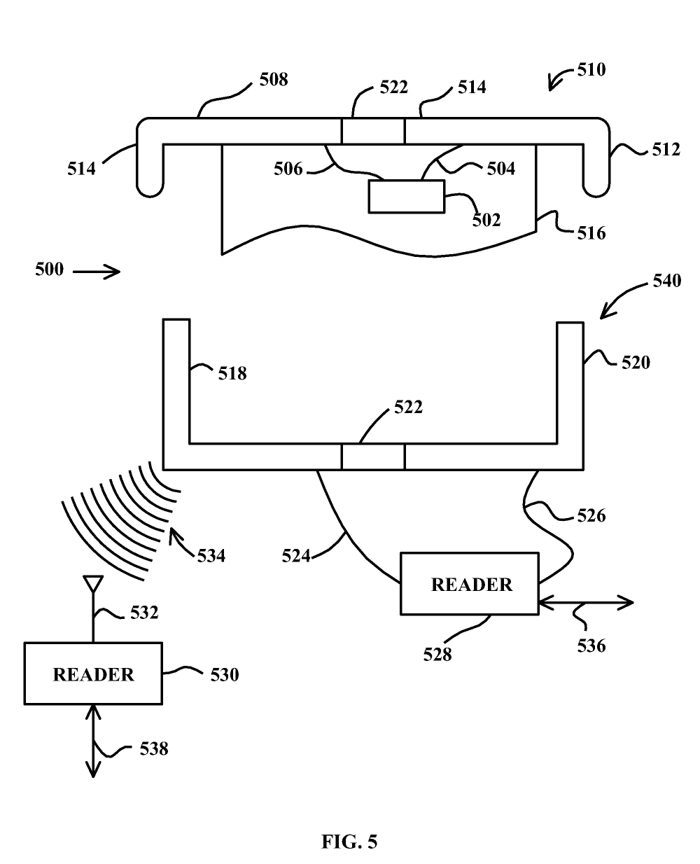

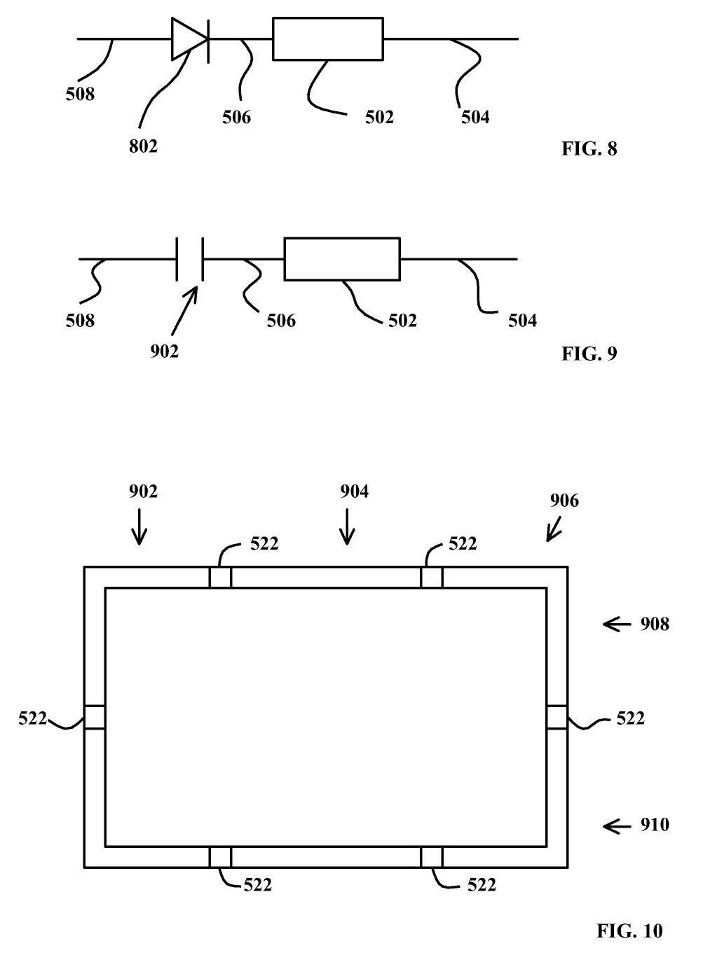

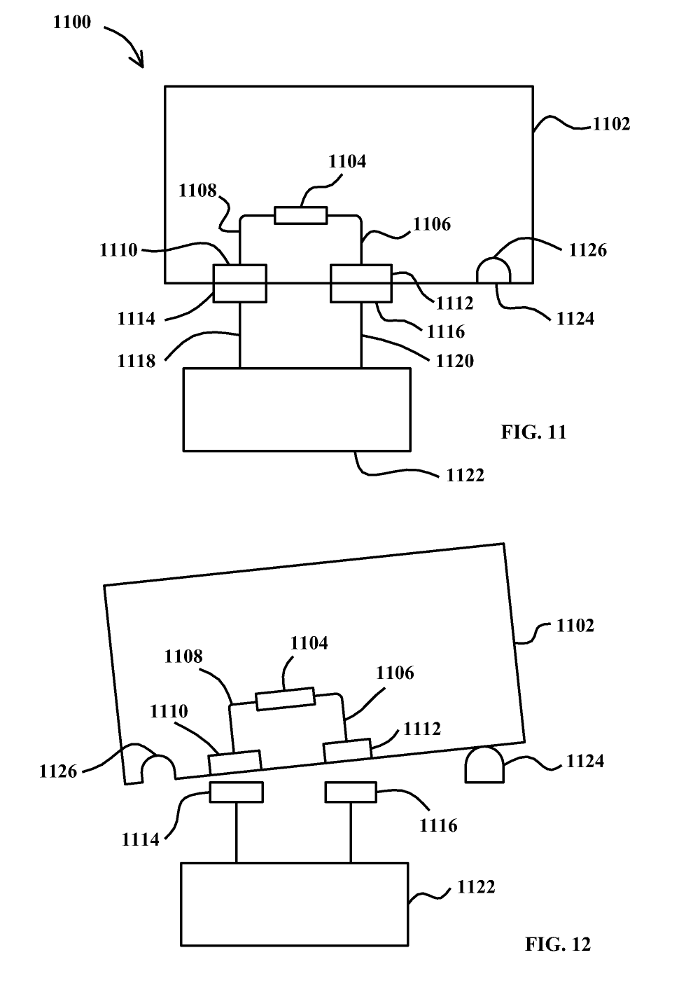

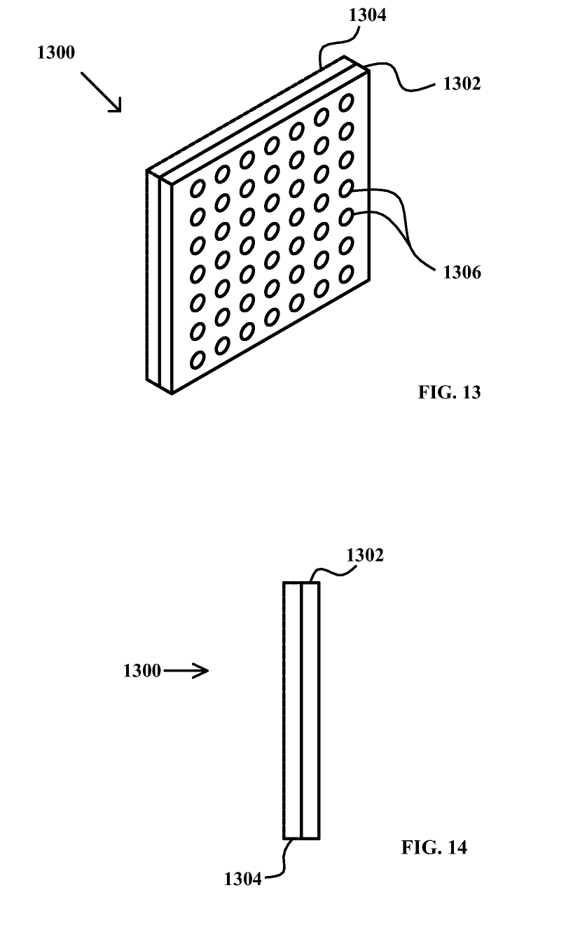

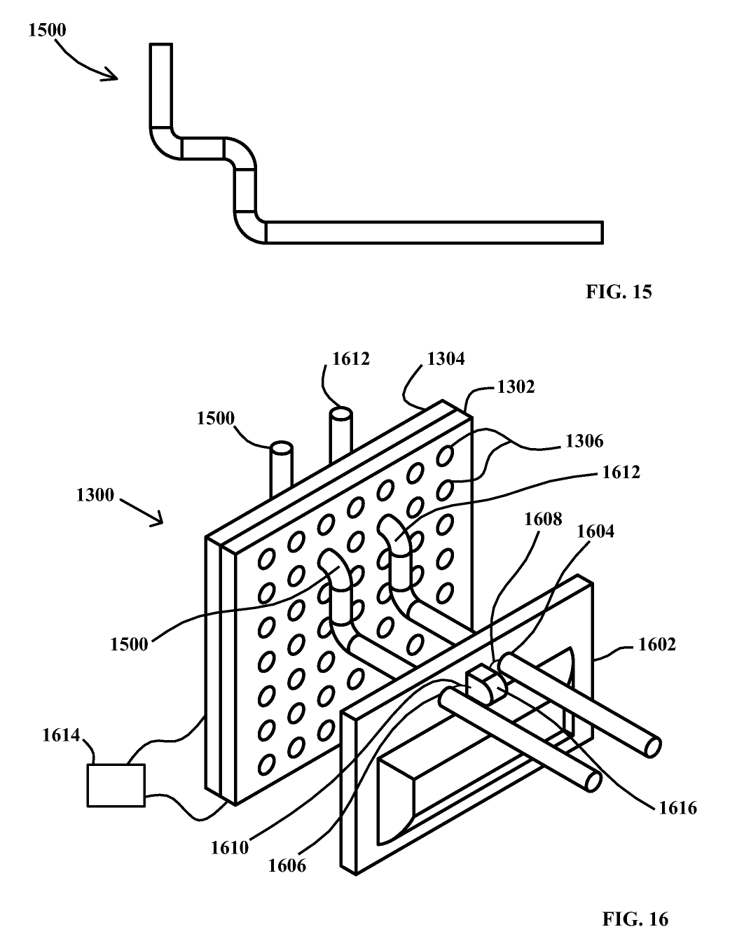

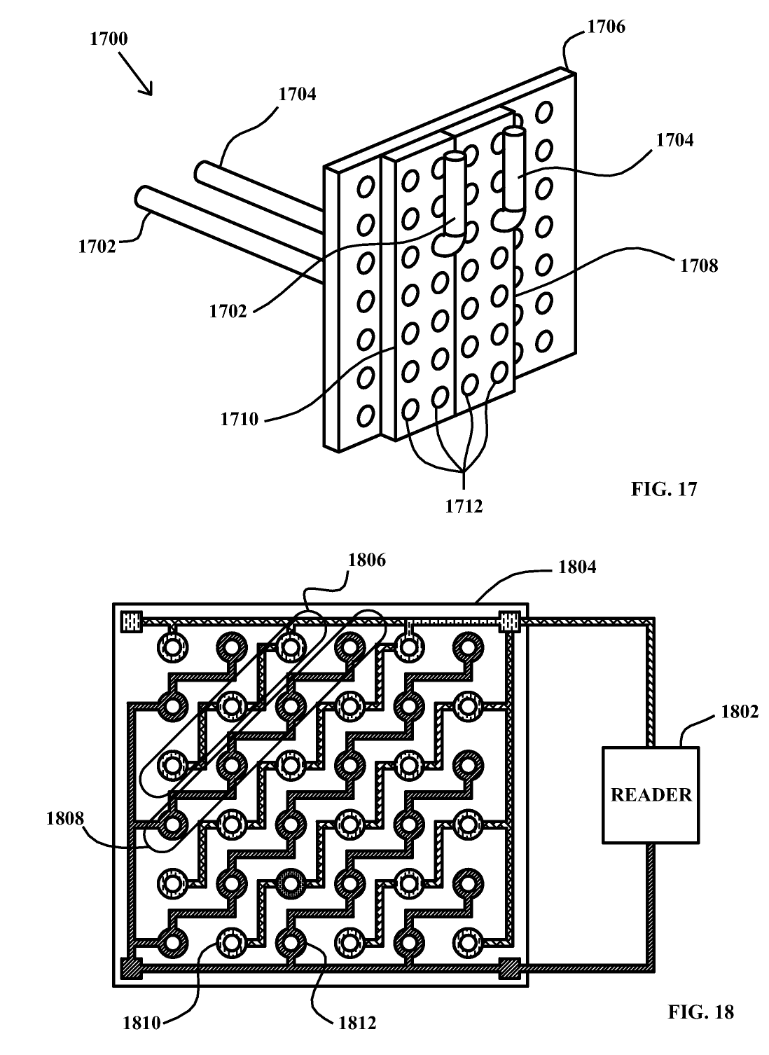

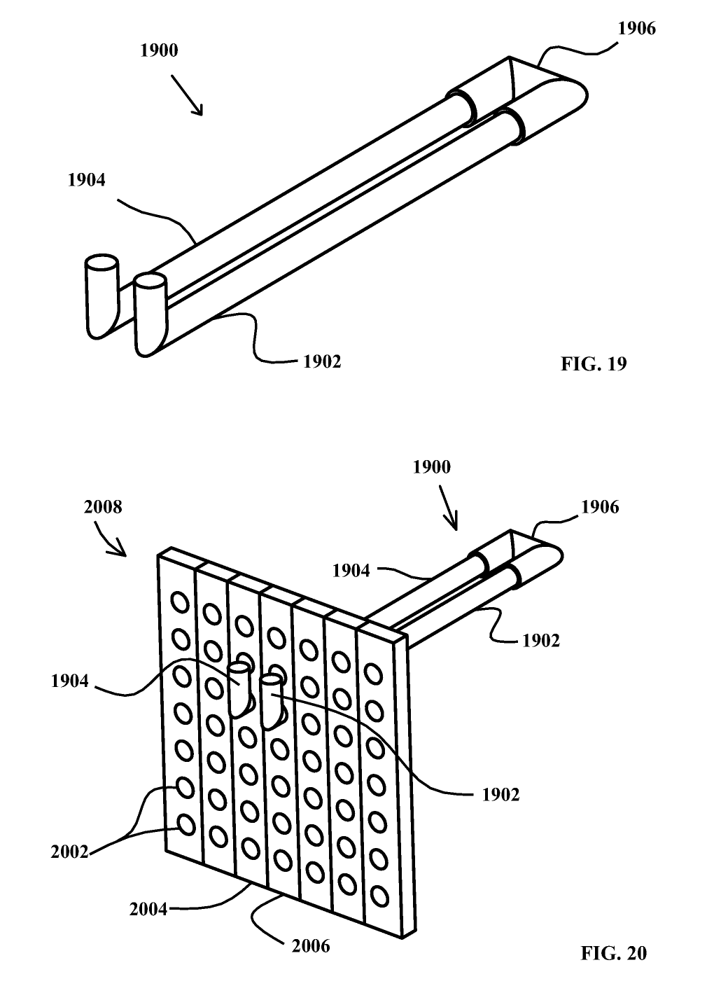

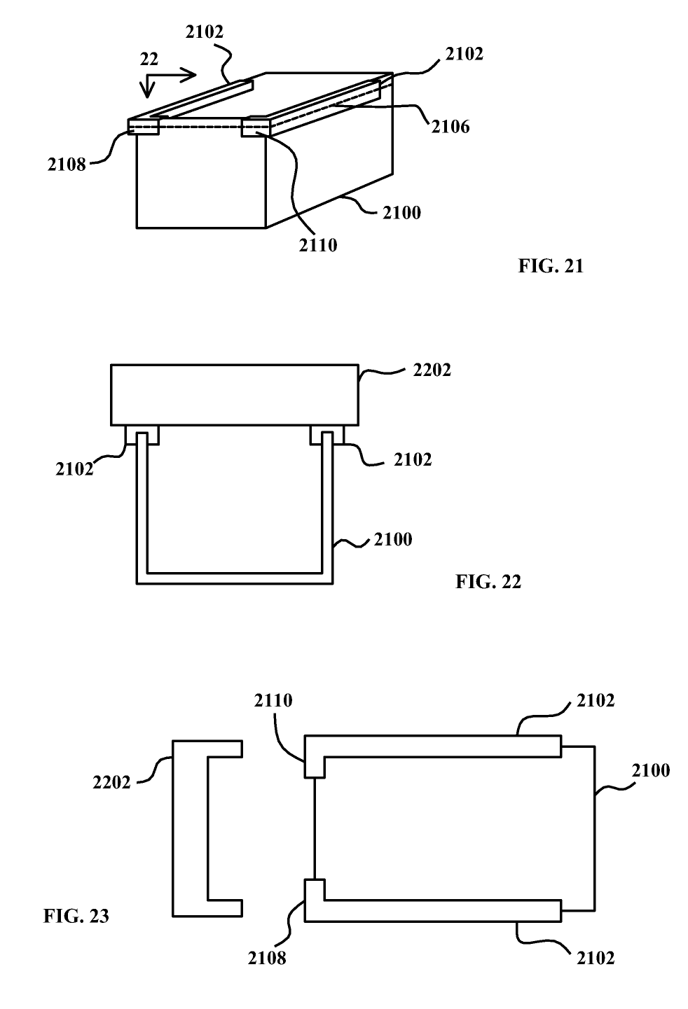

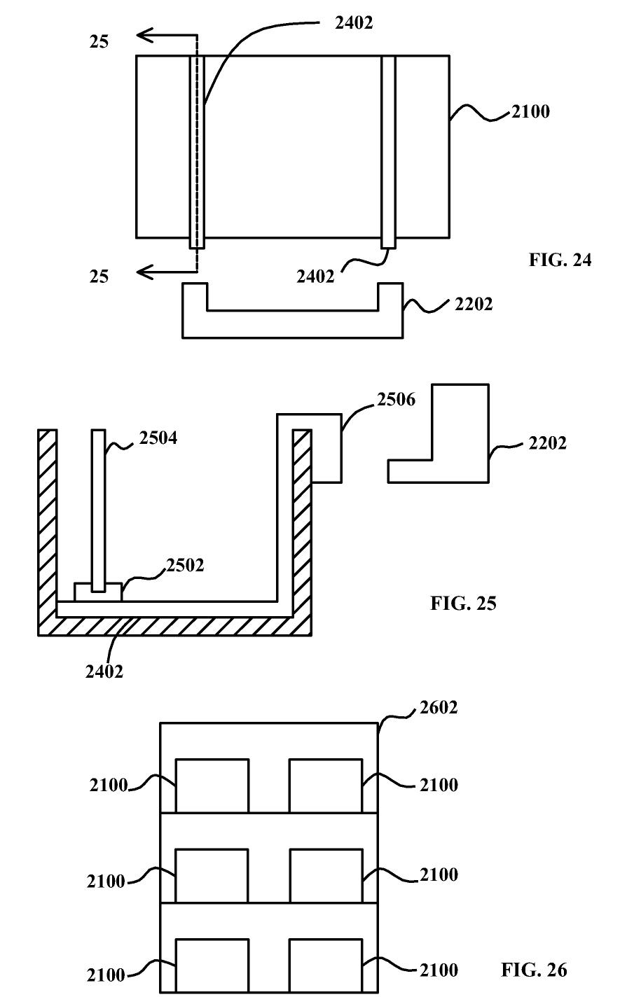

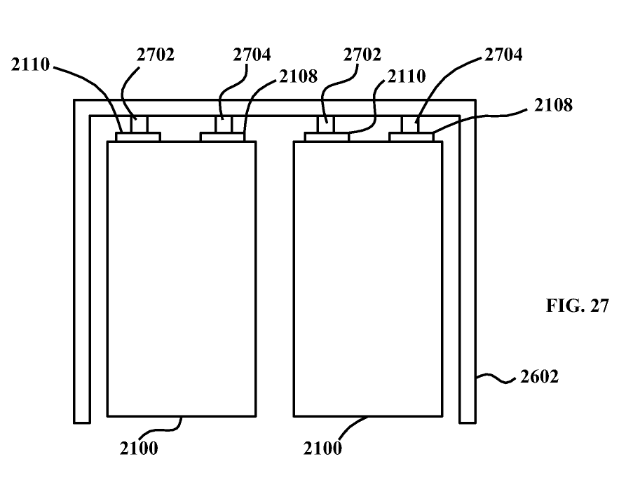

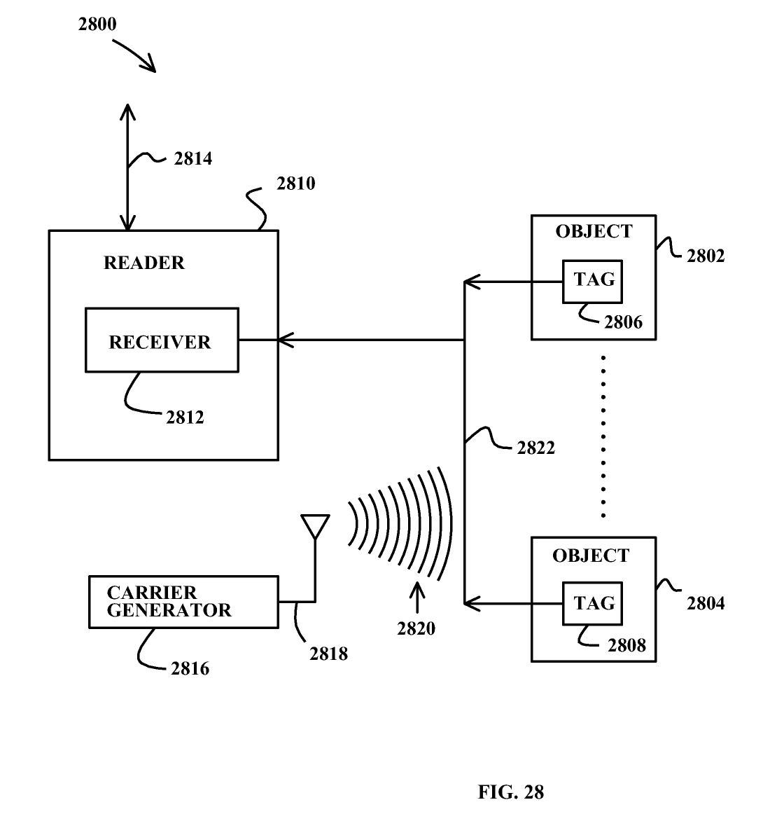

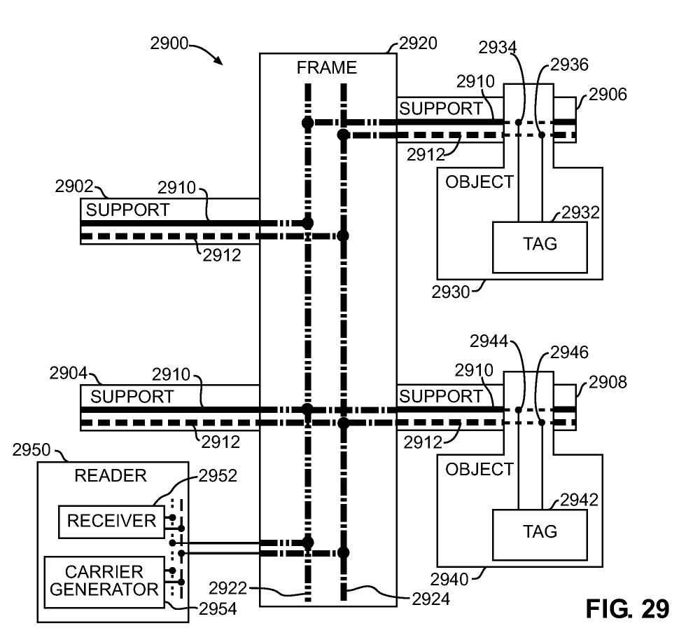

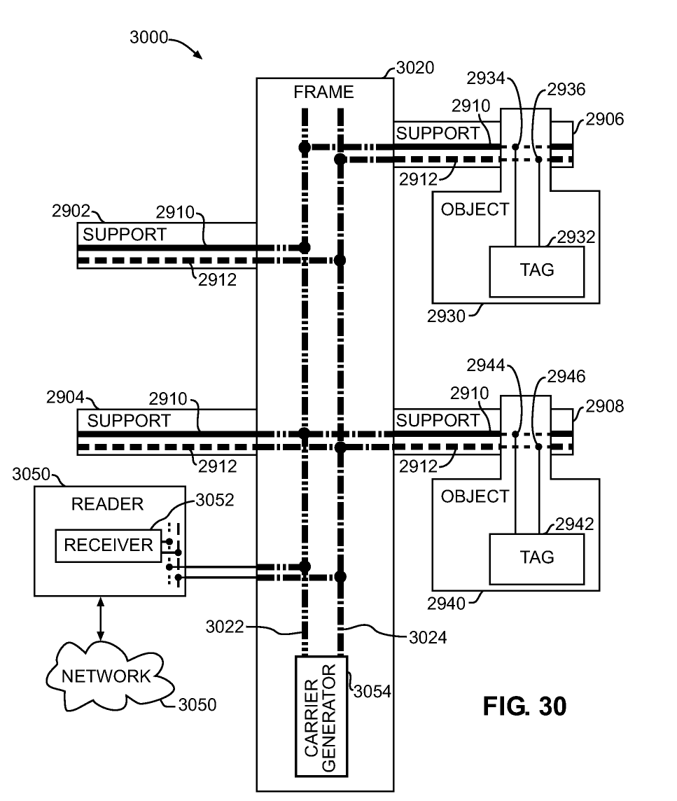

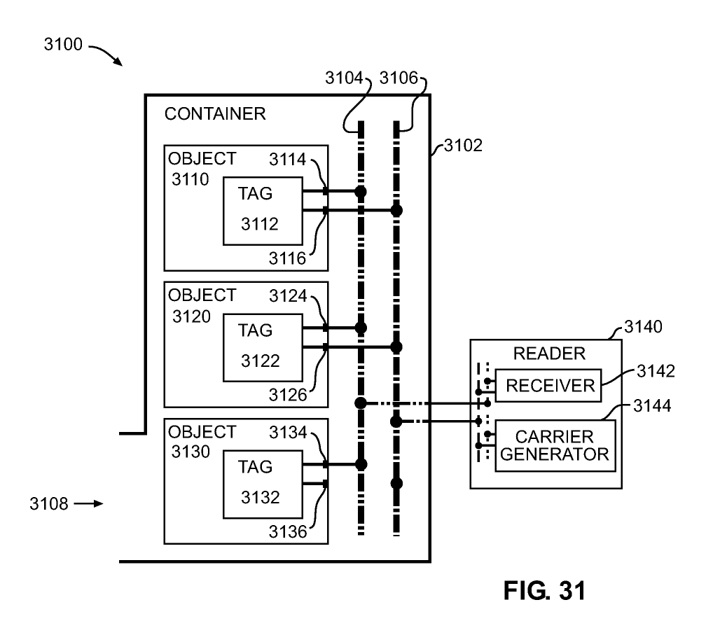

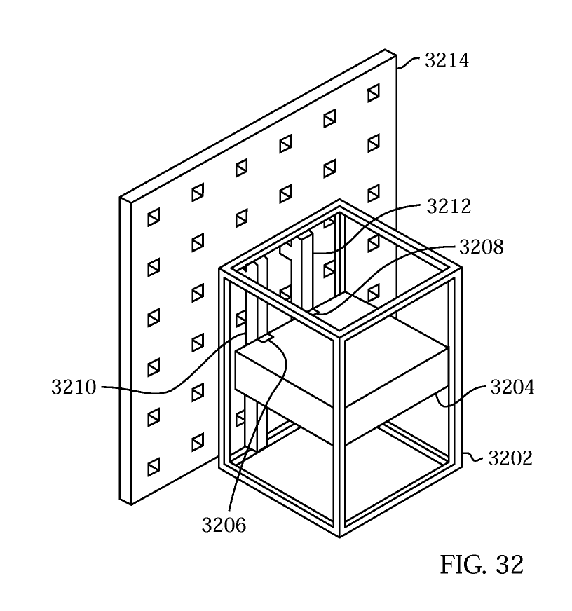

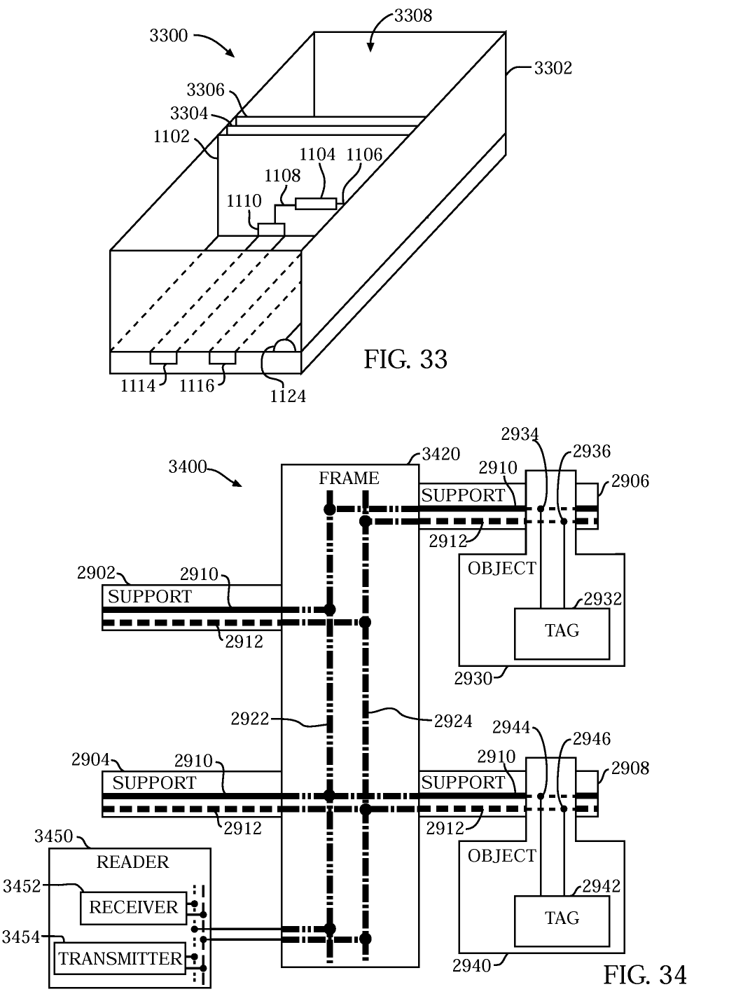

For example, systems 100, 200, 300, 400, 2800, 2900, 3000, 3100, and 3400 of FIGS. 1-34, according to various aspects of the present invention, identifies, tracks, monitors, displays, and/or stores objects.

System 100 may include reader 110, one or more tags 106-108, carrier generator 116, conductor 118, and communication link 114. Each tag 106-108 is associated with an object 102-104 respectively.

System 200 may include reader 210 having antenna 218, one or more tags 206-208, carrier generator 216, conductor 222, and communication link 214. Each tag 206-208 is associated with an object 202-204 respectively. An antenna may be omni-directional or directional.

System 300 may include reader 310 having antenna 318, one or more tags 306-308, carrier generator 316 having antenna 322, conductor 326, and communication link 314. Each tag 306-308 is associated with an object 302-304 respectively.

System 400 may include reader 410 having antenna 418, one or more tags 406-408 each one tag having respective antennas 424-426, power supply 416, conductor 428, and communication link 414. Each tag 406-408 is associated with an object 402-404 respectively.

System 2800 may include reader 2810, one or more tags 306-308, carrier generator 2816 having antenna 2818, conductor 2822, and communication link 2814. Each tag 2806-2808 is associated with an object 2802-2804 respectively.

System 2900 may include frame 2920 having two conductors 2922 and 2924; a plurality of supports 2902, 2904, 2906, and 2908 each respectively having two conductors 2910 and 2912; a plurality of tags 2932 and 2942 each tag mechanically coupled to a respective object 2930 and 2940; and reader 2950 having receiver 2952 and carrier generator 2954.

System 3000 may include frame 3020 having two conductors 3022 and 3024 and carrier generator 3054; a plurality of supports 2902, 2904, 2906, and 2908 each respectively having two conductors 2910 and 2912; a plurality of tags 2932 and 2942 each tag mechanically coupled to a respective object 2930 and 2940; and reader 3050 having receiver 3052 and a link to network 3050.

System 3100 may include container 3102 having two conductors 3104 and 3106; a plurality of tags 3112, 3122, and 3132 each tag mechanically coupled to a respective object 3910, 3120, and 3130; and reader 3140 having receiver 3142 and carrier generator 3144. System 3100 may further include opening 3108 for dispensing objects 3910, 3120, and 3130. Opening 3108 may further be used to restock container 3102 with objects.

System 3400 may include frame 3420 having two conductors 2922 and 2924; a plurality of supports 2902, 2904, 2906, and 2908 each respectively having two conductors 2910 and 2912; a plurality of tags 2932 and 2942 each tag mechanically coupled to a respective object 2930 and 2940; and reader 3450 having receiver 3452 and transmitter 3454.

A tag associates with an object for identifying, tracking, and/or monitoring the object. At least one tag associates with each one object. Preferably, at least one tag uniquely associates with a each object. Association of a tag with an object may include a mechanical coupling between the tag and the object. Preferably, a tag mechanically couples to an object. Mechanical that attaches a tag to an object. Mechanical coupling includes attaching with an adhesive (e.g., glue, tape, potting), positioning in a mounting structure (e.g., recess, pocket), and fastening with a fastener (e.g., bolt, screw, nail). For example, tag 106 is mechanically fastened to object 102 using an adhesive.

A tag may couple to a reader for communication. Coupling includes an electrical coupling for communication through a conductor and electromagnetic coupling for communication through an RF signal. Electrically coupling through and/or to a conductor includes physically contacting the conductor in such a manner that a current flows through the conductor responsive to voltage. Electromagnetically coupling includes coupling in such a manner that an electromagnetic wave (e.g., radio frequency wave) induces a flow of current in a conductor while the device producing the electromagnetic wave does not contact the conductor.

A coupling for communication through a conductor may include a first conductor for communicating an information and a second conductor for completion of an electrical circuit. A circuit between a tag and a reader may be established using a first conductor for transporting indicia of information (e.g., signal) and a second conductor for providing a reference signal (e.g., ground, DC voltage, DC current, AC voltage, AC current). In another implementation, a circuit between a tag and a reader may be established using only a first conductor when both the tag and the reader have connections to a ground or a common.

A tag may include a terminal to establish an electrical coupling to a conductor.

In an implementation, communication between a tag and a reader is performed in a unidirectional manner. A reader does not send information and/or control signals to a tag. A tag does not receive information and/or control signals from a reader. A reader does not individually address (e.g., select, poll, query) an individual tag. Any conventional communication protocol may be used by to provide unidirectional communication between a tag and a reader.

In another implementation, communication between a tag and a reader is performed in a bidirectional manner. Communication may occur serially or in parallel. A reader may send information to and receive information from a tag and visa versa. Information may include an address, data, status, and/or control signals. A reader may select (e.g., address) an individual tag or a group (e.g., family, class) of tags for bidirectional communication using any conventional protocol (e.g., bit mask, broadcast ID, wakeup message).

A tag does not communicate with any other tag. A tag does not receive information and/or control signals from any other tag. A tag does not send information and/or control signals to any other tag.

A tag may store information. Information may be stored as a record. A record may include a format for storing information particular to a type of media.

A tag may provide (e.g., communicate) information to a reader. Information may include information regarding an object as set forth above. A tag may include a media for storing and retrieving the record. A media includes any conventional memory (e.g., flash, ram, hard disk, ROM, mask programmable ROM). Storing information in a memory includes any conventional methods for writing to a memory (e.g., write to memory, mask programming of a memory in manufacture). Retrieving a record from a memory includes any conventional methods for reading data from a memory (e.g., read from memory). A memory may be a write-once, read-many memory (e.g., flash, ROM, mask programmable ROM).

A tag may receive a carrier, modulate the carrier to produced a modulated carrier, and transmit (e.g., communicate) the modulated carrier. A tag may receive a carrier from a carrier generator. A tag may include a carrier generator as a module of the tag. A tag may include an antenna for transmitting a modulated carrier as an RF signal. A tag may provide (e.g., conduct) a modulated carrier through a conductor. A plurality of tags may couple to a conductor to modulate a carrier provided by the conductor.

A carrier generator provides a carrier. A carrier generator may provide energy to a passive tag. A carrier includes any type of energy suitable for modulation (e.g., a voltage, a current, an electromagnetic field). A carrier includes any waveform suitable for modulation (e.g., DC, sinusoidal, square wave, step). A carrier may be modulated to produce a modulated carrier. Modulation impresses data (e.g., indicia of information) onto a carrier. A tag may modulate a carrier in accordance with the information stored by the tag. A plurality of tags may modulate (e.g., simultaneously, at discrete times) a carrier in accordance with the respective information stored by each tag of the plurality of tags. A carrier modulated in accordance with information of a tag or a plurality of tags includes indicia of the information used to perform the modulation. An unmodulated DC and/or AC carrier does not provide information.

A tag may be passive (e.g., lacking an internal source of energy). A carrier may provide energy to a tag to perform an operation of the tag. An operation of the tag includes modulation of the carrier.

A method for modulating a carrier may include pulse modulation, pulse position modulation, on-off keying, loading and unloading, amplitude modulation, and power storage and active signal delivery at different frequencies.

A carrier generator may provide a carrier to a tag or a plurality of tags through a conductor and/or as an RF signal transmitted to a conductor (e.g., antenna).

A carrier generator may be a module separate from a tag and/or a reader. A carrier generator may be a module of a tag, a reader, a frame, and/or a support. A carrier generator may be separate from a tag, a reader, a frame and/or a support and removeably coupled to a tag or plurality of tags, possibly through a frame and/or a support, only while reading information from the tag or plurality of tags.

A reader receives information from one or more tags (e.g., simultaneously, at discrete times). A reader may detect indicia of information sent by a tag or a plurality of tags. A reader may include a receiver for receiving a modulated carrier. A receiver may detect indicia of information in the modulated carrier. A receiver may extract (e.g., demodulate) indicia of information from the modulated carrier. A receiver may convert (e.g., analog-to-digital conversion, decode, unencrypted) indicia of information into a form useable by a reader. A receiver may provide the information transmitted by each tag respectively to a reader.

A receiver may receive a modulated carrier through a conductor and/or as an RF signal. A receiver may include a contact for electrically coupling to a conductor to receive the modulated carrier. A receiver may include an antenna that receives an RF signal that includes the modulated carrier.

A reader may store information received from a one or more tags. A reader may perform an operation in accordance with information received from one or more tags (e.g., execute a process in accordance with a formula provided by one or more tags, use information from a tag to access a database). A reader may analyze information from one or more tags alone or in conjunction with other information (e.g., compare, combine, detect differences, extrapolate, search a database). A reader may provide a report regarding information received from one or more tags (e.g., objects in inventory, number of objects, age of objects, location of objects). A reader may provide a warning in accordance with information received from one or more tags (e.g., missing objects, incompatibility of objects).

A reader may communicate with a device, other than tags, (e.g., keyboard, display, internet, database, computer) in a bidirectional manner. A reader may communicate information received from one or more tags to a device. A device may perform an operation, analyze information, provide reports, and provide warnings as described above. A device may provide data to a reader for performance of an operation. A reader may communicate with a device using any conventional protocol and/or technology.

A conductor conducts an electrical energy (e.g., a voltage, a current, a waveform, a field). A conductor may radiate an electrical potential as an electromagnetic field (e.g., RF signal). A conductor may coupled to signal generator (e.g., wired, wirelessly) to receive a carrier. A conductor may provide a carrier to one or more tags. One or more tags may couple to a conductor to modulate the carrier. A conductor may provide a potential to one or more tags that is not modulated by the tags, but that energizes each tag to perform an operation. A conductor may include a metal, a semiconductor, and a superconductor. Portions of a conductor may be covered by an insulator to protect against shorting out a circuit.

Any number of conductors may couple between any number of modules to complete a circuit. A frame may include a conductor. A support may include a conductor. A conductor in a support may establish an electrical coupling to a conductor in a frame by mechanically coupling to the frame. A plurality of supports may mechanically and electrically couple to a frame. A reader may electrically couple to a frame and/or a support.

Mechanically coupling to an object may include establishing contact between conductors to provide an electrical connection between the conductors. Accomplishing a mechanical coupling may result in an electrical coupling. An electrical coupling of two conductors provides a conductor for communication of information. For example, a support may mechanically couple to a frame in such a manner as to establish an electrical connection between the support and at least a portion of the frame as a result of the mechanical coupling. An object may be supported by a support in such a manner that a terminal of a tag contacts and electrically couples to a conductor of the support thereby establishing an electrical connection between the support and the tag.

A power supply provides an electrical potential to one or more tags to energize the tags. A carrier generator may provide a carrier and simultaneously provide an electrical potential to one or more tags.

For example, tags 106-108 mechanically couple to objects 102 and 104 respectively. Tags 106-108 store information regarding objects 102-104 respectively. In one implementation, tags 106 and 108 store a unique identification number. Reader 110 and/or a device coupled to reader 110 via communication link 114 uses the unique identification number to index into a database that contains a property of each respectively object.

Each tag 106-108 electrically couples to first conductor 118. Carrier generator 116 couples to first conductor 118. Carrier generator 116 provides a carrier to a first conductor 118. Carrier generator 116 may further coupled to each tag 106-108 with a second conductor (not show) to complete an electrical circuit with tags 106-108 or to a common ground.

Tags 106-108 modulate the carrier provided by carrier generator 116 to produce a modulated carrier. The carrier provided by carrier generator 116 may further provide the energy to energize tags 106-108 to modulate the carrier. Tags 106-108 may modulate the carrier simultaneously or at discrete times. In an implementation, tags 106-108 continuously modulate the carrier upon being energized. In another implementation, tags 106-108 wait a random amount of time before modulating the carrier a first time and any subsequent times. A random pause may result in a time where only one tag modulates the carrier and thereby does not collide with modulation by any other tag. In another implementation, a tag intermittently modulates the carrier. A tag may include a simple state machine (e.g., combination of electronic logic devices) to control modulation of the carrier. A tag may also include a processor (e.g., a circuit that runs a stored program) to control modulation of the carrier.

Receiver 112 of reader 110 electrically couples to first conductor 118 to receive the modulated carrier. Receiver 112 receives a modulated carrier, detects the indicia of information in the modulated carrier, extracts indicia of information from the modulated carrier, and converts the indicia of information into information from each respective tag 106-108.

In an implementation, receiver 112 mechanically and electrically couples to first conductor 118. In another implementation, receiver 112 temporarily electrically couples to first conductor 118 and subsequently temporarily electrically couples to other conductors coupled to other tags (e.g., portable reader).

In another implementation, reader 110 includes carrier generator 116. Coupling receiver 112 to first conductor 118 provides a carrier to first conductor 118 and also receives the modulated carrier from first conductor 118.

In another example, tags 206-208 mechanically couple to objects 202 and 204 respectively. Tags 206-208 store information regarding objects 102-104 respectively. In one implementation, tags 206 and 208 store a unique identification number as described above. In another implementation, tags 206-208 further store information regarding a property of objects 202 and 204 respectively. For example, if objects 202-204 were cans of base paint, tags 206-208 may store manufacture information, acceptable pigment combinations for mixing with each can of base paint, and a can serial number. Reader 210 and/or a device coupled to reader 210 via communication link 214 may use pigment combination information to control a paint tinting device to add acceptable pigments to each respective can according to customer requests. The information may also be used to provide a warning when a customer requests a pigment combination that is not acceptable for a particular can of base paint.

Each tag 206-208 electrically couples to first conductor 222. Carrier generator 216 couples to first conductor 222. Carrier generator 216 provides a carrier as described above. Tags 206-208 are energized by the carrier and modulate the carrier to produce a modulated carrier as described above. First conductor 222 radiates the modulated carrier as an electro-magnetic RF signal thereby operating as an antenna to each tag 206-208 coupled to first conductor 222.

Receiver 212 of reader 210 includes antenna 218 for receiving radiated RF signal 220 that includes the modulated carrier. Receiver 212 wirelessly receives a modulated carrier through antenna 218, detects the indicia of information in the modulated carrier, extracts indicia of information from the modulated carrier, and converts the indicia of information into information from each respective tag 206-208 in a form usable to reader 210.

In another example, tags 306-308 mechanically couple to objects 302 and 304 respectively. Tags 306-308 store information regarding objects 302-304 respectively. In one implementation, tags 306 and 308 store a unique identification number as described above. In another implementation, tags 306-308 further store information regarding a property of objects 302 and 304 respectively. For example, if objects 302-304 were lottery tickets, tags 306-308 may store information regarding the type of lottery game, instant winner information, and a card serial number. Reader 310 and/or a device coupled to reader 310 via communication link 314 may combine information from the tag with purchaser information provided at the point-of-sale to payout any winnings or to identify future winnings.

Each tag 306-308 electrically couples to first conductor 326. Carrier generator 316 does not electrically couple to first conductor 326, but wirelessly transmits a carrier to first conductor 326. Carrier generator 316 includes antenna 322 that transmits a carrier to first conductor 326 as an RF signal 324. Carrier RF signal 324 induces the carrier into first conductor 326 for modulation by tags 306-308. Tags 306-308 are energized by the carrier and modulate the carrier to produce a modulated carrier as described above. First conductor 326 radiates the modulated carrier as an electromagnetic RF signal 320 thereby operating as an antenna to each tag 306-308 coupled to first conductor 326.

Receiver 312 of reader 310 includes antenna 318 for receiving radiated RF signal 320 that includes the modulated carrier. Receiver 312 wirelessly receives a modulated carrier through antenna 318, detects the indicia of information in the modulated carrier, extracts indicia of information from the modulated carrier, and converts the indicia of information into information from each respective tag 306-308 in a form usable to reader 310.

In another example, tags 406-408 mechanically couple to objects 402 and 404 respectively. Tags 406-408 store information regarding objects 402-404 respectively. In one implementation, tags 406 and 408 store a unique identification number as described above.

Each tag 406-408 electrically couples to first conductor 428. Power supply 416 electrically couples to first conductor 428. Power supply 416 provides an electric potential that energizes tags 406-408. Power supply 416 may provide a second conductor that couples to each tag 406-408 to complete an electrical circuit.

Each tag 406-408 includes a respective carrier generator that provides a carrier for modulation. Each tag 406-408 individually modulates its respective carrier to provide a respective modulated carrier. Each tag 406-408 transmits its respective modulated carrier through respective antennas 424-426 as electromagnetic RF signals 420 and 422 respectively.

Receiver 412 of reader 410 includes antenna 418 for receiving radiated RF signals 420-422 that include respective modulated carriers. Receiver 412 wirelessly receives the respective modulated carrier through antenna 418, detects the indicia of information in the modulated carriers, extracts indicia of information from the modulated carriers, and converts the indicia of information into information from each respective tag 406-408 in a form usable to reader 410.

Reader 410 may communicate with a device via communication link 414.

In another example, tags 2806-2808 mechanically couple to objects 2802 and 2804 respectively. Tags 2806-2808 store information regarding objects 2802-2804 respectively. In one implementation, tags 2806 and 2808 store a unique identification number as described above. Each tag 2806-2808 electrically couples to first conductor 2822. Carrier generator 2816 does not electrically couple to first conductor 2822, but wirelessly transmits a carrier (e.g., an electromagnetic signal) to first conductor 2822. Carrier generator 2816 includes antenna 2818 that transmits a carrier to first conductor 2822 as an RF signal 2820. Carrier RF signal 2820 induces the carrier into first conductor 2822 for modulation by tags 2806-2808. Tags 2806-2808 are energized by the carrier and modulate the carrier to produce a modulated carrier as described above.

Receiver 2812 of reader 2810 electrically couples to first conductor 2822 to receive the modulated carrier. Receiver 2812 receives a modulated carrier, detects the indicia of information in the modulated carrier, extracts indicia of information from the modulated carrier, and converts the indicia of information into information from each respective tag 2806-2808.

Receiver 2812 may mechanically and electrically couple to first conductor 2818 or temporarily electrically couples to first conductor 2822 as described above.

Examples of implementations, according to various aspects of the present invention, include a system for files, cards, a pegboard display, a retrofit kit, and storage of boxes.

In one implementation, a file system 500 for non-electronic documents (e.g., file, file folder, hanging file, envelop, red rope folder, x-ray folder) includes one or more readers and one or more tags. File system 500 may provide control of files, control of access to files, notification of the location of files, an index of the files located in a storage area (e.g., a filing cabinet) location and/or notice of misplaced or misfiled files, organization of files by content, and reports the contents of a file.

In one implementation, a file system includes hanging file folder 510, tag 502, reader 528 and/or 530, and conductors between tag 502 and reader 528. A file system may further include communication links 536 and 538 to another device (e.g., network) (not shown) for communicating with readers 528 and 530 respectively.

Tag 502 mechanically couples to file folder 510. Tag 502 communicates with reader 528 through an electrical connection provided by a first conductor or with reader 530 through a wireless connection that detects an RF signal radiated by a first conductor. The first conductor includes wire 506, metallic hook 508, end portion 514 of metallic hook 508, rail 518, and wire 524. A second conductor may complete a circuit between reader 528 and tag 502. The second conductor includes wire 504, metallic hook 514, end portion 512 of metallic hook 514, rail 520, and wire 526. An electrical connection between end portions 512, 514 and rails 520, 518 respectively may be formed while file folder 510 rests on rack 540. Rack 540 includes rail 518, rail 520, and separator 522. Separators 522 electrically separate the first conductor from the second conductor.

A file system may include one or more files. In one implementation, file system 500 includes hanging file folder 510 and 602. Documents are placed in hanging portion 516 of each hanging file folder 510 and 602. Hanging portions 516 couple to hooks (e.g., 508, 514) that hang on rack 540. In one implementation, each respective tag of each hanging file folder 510 and 602 stores a unique identification number. Reader 528 and/or reader 530 receives a unique identification number from each tag using any method described above. Reader 528 and/or reader 530 uses the unique identification number to index a database stored by the reader or by a device coupled to the readers via their respective communications links. The database contains a description of the contents of each file folder. The database, not the tag, is updated to reflect any changes in the content of any file folder.

Reader 528 may include a carrier generator to provide a carrier to tag 502 while tag 502 is electrically coupled to reader 528. A carrier generator (not shown) may also be coupled to the first conductor separate from reader 528 and/or reader 530. Reader 530 may include a carrier generator that wirelessly provides a carrier to hook 508 while hanging file folder 510 is not electrically coupled to rail 518. While hanging file folder 510 is not coupled to rail 518, reader 530 may receive an RF signal radiated by hook 508 that includes a modulated carrier.

In one implementation of file system 500, a carrier generator (not shown) provides a DC voltage potential to the first conductor and a reference voltage potential to the second conductor (e.g., common, ground). The DC voltage potential energizes the tags of each hanging file folder 510 and 602. Each tag of each file folder 510 and 602 operates as a variable load (e.g., variable impedance). Variation of the load of a tag affects (e.g., perturbs, modulates) the DC voltage potential provided by the carrier generator. Each tag varies its respective impedance by shorting the DC voltage potential to the reference voltage potential and releasing the short. A tag varies its impedance in accordance with the information stored in each respective tag. Reader 528 and/or reader 530 detects the variations (e.g., perturbations, modulations) in the DC voltage potential caused by the variation of the load of each tag. The pattern of the variations is indicia of the information being sent by each tag. Any conventional encoding may be used to correlate information stored in each tag to variations of the DC voltage potential.

Readers 528 and/or 530 do not modulate the carrier provided to the first conductor; accordingly, the communication between tags and readers 528 and/or 530 is unidirectional (e.g, from each tag to a reader).

A hanging file folder and a rail may include more than one conductor. In one implementation, hook 508 includes two conductors 600 and 602 that electrically couple to conductors 604 and 606 respectively of rail 518. Multiple conductors may be used to provide higher bandwidth and greater reliability.

A directional device protects a tag from application of an electrical potential and/or carrier that may harm the tag. In one implementation, a directional device includes diode 802. While an electric potential and/or carrier is applied to hook 508, tag 502 may perturb the electric potential and/or carrier on hook 508, but not wire 504. Accordingly, proper operation of tag 502 occurs when an electric potential and/or carrier provided to hook 508 is greater than the electrical potential provided to wire 504 via hook 514.

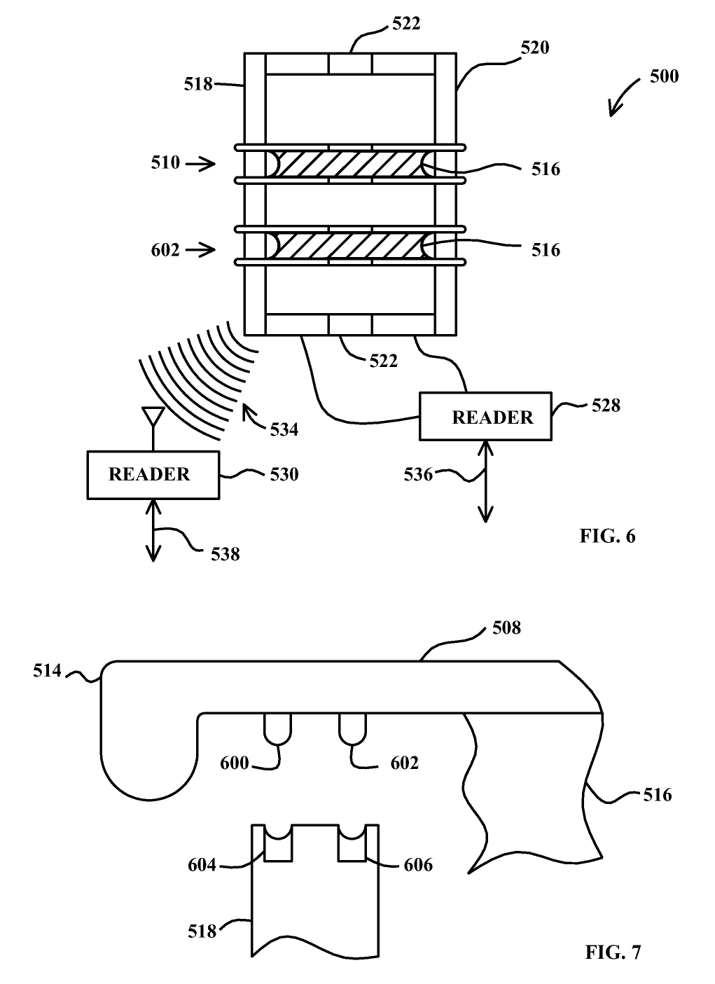

In another implementation, diode anode is coupled to hook 308 for all hanging file folders (e.g., 510, 602). When hanging file folders are placed on rack 540 (e.g., FIG. 6), hook 508 for some hanging folders may contact rail 518 while hook 508 for other hanging folders may contact rail 520. A carrier may be provided to rail 518 to receive information from the tags associated with hanging file folders whose hook 508 contacts rail 518. A carrier may be provided to rail 520 to receive information from the tags associated with hanging file folders whose hook 508 contacts rail 520.

In another implementation, a directional device includes capacitor 902. A carrier generator may provide an AC carrier to the rail that couples to hook 508 for modulation by tag 502.

As set forth above, reader 528 and/or reader 530 cannot address (e.g., select, enable, disable) and communicate (e.g., enable, disable) with an individual tag to the exclusion of any other tag. Accordingly, a reader cannot command the tag to activate an indicator to provide indicia a physical location.

Indication of physical location of a tag may be provided indirectly. A reader may detect when it receives information from a particular tag (e.g., unique identification number). A system may be arranged in such a manner that a reader services a defined physical area. Accordingly, receiving information from a particular tag is also an indication to the reader of the physical location of the tag (e.g., within the defined physical area). A defined physical area may include a room, a peg board, a drawer, a filing cabinet, a shelf, a card holder, a container, and a rail pair.

A rail pair may be segmented to provide a finer granularity of physical location indication. Rails 908 and 910 may be divided into electrically separate sections 902-906 by separators 522. Each section 902-906 may be serviced by a different reader (not shown) or a reader that services multiple conductors (e.g., multiplexer). Each reader may indicate (e.g., light, sound, tactile indicators, electronic message) receipt of a particular record from one of the three sections. A rail, or any other physical location, may also be segmented to increase throughput or decrease collisions between transmissions made by a plurality of tags.

A system may simultaneously identify, track, monitor, display and/or store an object or a plurality of objects. A system may include structures for displaying and/or storing while coupling a reader to one or more tags for identifying, tracking, and/or monitoring.

A system that identifies, tracks, monitors, displays and/or stores an object or a plurality of objects may support, and/or enclose the object.

Supporting an object may include supporting all or a portion of the weight of an object. Supporting an object may include mechanically coupling to an object. Supporting an object may include the object resting on the support in such a manner that the force of gravity holds at least a portion of the object in contact with the support.

Enclosing an object includes surrounding, confining, holding within, and/or enveloping an item. Enclosing may include surrounding an item on all sides of the item and confining its movement in a manner that permits dispensing of a number of items at a time. Enclosing may include holding items within a container until an opening is established for dispensing the items. A container that encloses may include a container that has an opening for stocking the container with items and an opening for dispensing a number of items at a time from the container.

A container may physically position an object inside the container in such a manner as to provide an electrical connection between a conductor (e.g., inside the container) associated with the container and a terminal on the object. The electrical connection between the conductor and the terminal may provide a conduit for transferring information regarding each object respectively inside the container.

In one implementation, storage system 3300 identifies, tracks, monitors, and store a plurality of cards. A card sample may be mounted on a front of container 3302 to display the cards. Container 3302 supports cards 1102, 3304, and 3306. Container 3302 positions each card so that respective contacts 1110 and 1112 (not shown) align with contacts 1114 and 1116. A reader (not shown), couples to contacts 1114 and 1116 to receive information from each tag 1104 respectively of each card 1102, 3304, and 3306. Top 3308 of container 3302 is open to permit dispensing and restocking of cards. Any conventional method and/or structure may be used to permit dispensing and restocking of the objects of a container.

System 3300 is a storage implementation of system 1100 for identifying, tracking, monitoring, storing, and displaying. System 1100 also operates with cards (e.g., business cards, brochures, lottery tickets, prepaid phone cards, paint chips). Cards may be stored or positioned for display and/or storage (e.g., bin, bins, shelves, racks, boxes, containers). Any implementation of a reader (e.g., wired, wireless) and a signal generator (e.g., wired, wireless) or power supply may be used with cards.

For example, system 1100 includes card 1102, reader 1122 and a first conductor. A second conductor completes a circuit between reader 1122 and tag 1104. Card 1102 includes tag 1104, wires 1106-1108, and contacts 1110-1112. Reader includes reader 1122, wires 1118-1120, and contacts 1114-1116. While contact 1110 is electrically coupled to contact 1114, the first conductor, which includes wire 1108, contact 1110, contact 1114, and wire 1118, electrically couples tag 1104 to reader 1122. Likewise, while contact 1112 is electrically coupled to contact 1116, the second conductor, which includes wire 1106, contact 1112, contact 1116, and wire 1120, electrically couples tag 1104 to reader 1122. Contacts 1114 and 1116 may simultaneously contact a plurality of cards.

A card may be keyed to position contacts on the card to align with contact of the reader. For example, while guide 1124 is positioned in notch 1126, contacts 1110 and 1112 align with contacts 1114 and 1116 respectively. Alignment leads to a higher likelihood of electrical contact between contacts of the card and contacts of the reader. While guide 1124 is not positioned in notch 1126, contacts 1110 and 1112 do not electrically couple with contacts 1114 and 1116 respectively.

A contact may be positioned on a surface of an object (e.g., conductive ink, foil, metal strip) or integrated into the object. In one implementation, a conductive label is wrapped around an edge of a card to provide a contact on two sides and an edge of the card. The conductive label may be mechanically mounted to the card using an adhesive.

Contacts may be positioned on an object in such a manner that the object must be in a predetermined position for the contacts of the object to align with and electrically couple with the contacts of the reader.

In another implementation, container 3102 completely encloses objects 3110, 3120, and 3130. Each object has tag 3112, 3122, and 3132 respectively. Container 3102 includes conductors 3104 and 3106 positioned on an inside of container 3102. Conductors 3104 and 3106 extend from the inside of container 3102 to an outside of container 3102 to provide contact and an electrical coupling to reader 3140. Container 3102 position objects 3110, 3120, and 3130 in such a manner that respective contacts 3114 and 3116 of tags 3112, 3122, and 3132 contact and electrically coupled to conductors 3104 and 3106. Carrier generator 3144 provides a carrier across conductors 3104 and 3106. Tags 3112, 3122, and 3132 receive and modulate the carrier to provide a modulated carrier. Receiver 3142 of reader 3140 detects the modulated carrier thereby receiving indicia of the information stored in each tag.

Container 3102 includes opening 3108 for dispensing objects 3110, 3120, and 3130. Container 3102 may have opening 3108 as a permanent part of the structure of container 3102 or container 3102 may completely enclose objects 3110, 3120, and 3130 until a time for dispensing arrives at which time opening 3102 may be formed by removing a portion of the structure of container 3102.

A system for displaying an object or a plurality of objects may also identify, track, and monitor the objects being displayed. A display system may also be used to store objects. A display system includes any conventional system that displays an object including shelves, racks, display cases, and drawers. A display system may be adjustable for displaying a variety of objects of different sizes.

A display system may include one or more frames and one or more supports. A frame anchors a display system. A frame provides stability, provides locations for coupling a reader, and/or a signal generator, provides locations for mechanically coupling to supports, provides locations for electrically coupling to supports, and establishes an area for display. A frame may provide a plurality of discrete locations for mechanically coupling to a support thereby providing selection in the placement of supports.

A support supports an object for display. A support positions an object for observation, access, and use. A support mechanically couples to a frame. A support may include any conventional structure that removeably couples to a frame without the use of tools. A frame may receive a portion of the structure of a support for mechanically coupling with or without the use of tools. For example, a support may include a portion that fits into a hole, a slot, and/or a groove in a frame. The structure of the support may interfere with the frame thereby mounting the support to the frame. Adjustable mechanical coupling may include placing a support into one of a plurality of holes, slots, dovetail grooves, and/or grooves.

A support may support one or more objects. An object may rest on a support (e.g., shelf), hang from a support (e.g., pegboard hook), and/or mechanically couple to a support. A support may support an object in such a manner as to establish an electrical coupling between the support and the object and/or a tag that is mounted to the object.

A frame and/or a support may include one or more conductors for coupling to one or more tags for identifying, tracking, and monitoring objects. Conductors of a frame may couple to conductors in a support. Establishing a mechanical coupling between a frame and a support may establish an electrically coupling between the conductors of a frame and the conductors of a support. Removal of a support from a frame may disconnect the conductors of the frame from the conductors of the support.

Conductors of a frame having two or more conductors may form a circuit for providing a carrier to one or more tags and receiving a modulated carrier from one or more tags. A frame having one conductor may form a circuit by coupling the frame to a ground while providing a carrier via the conductor.

Conductors of a support may couple to terminals of a tag. Placement of an object on a support may establish an electrical coupling between the conductors of a support and the terminals of a tag associated with the object. Removal of the object from the support may eliminate the electrically coupling between the conductors of the support and the terminals of the tag associated with the object. A support may include a single conductor such that an object must be supported by two supports to establish a electrical circuit with two terminals of a tag.

A receiver and/or a carrier generator may electrically and/or electromagnetically couple, permanently or removeably, to the conductors of a frame and/or a support.

In one implementation, display system 2900 includes frame 2920 and supports 2902, 2904, 2906, and 2908. Frame 2920 includes conductors 2922 and 2924. Supports 2902, 2904, 2906, and 2908 include respective conductors 2910 and 2912. Supports 2902, 2904, 2906, and 2908 mechanically couple to frame 2920. Mechanically coupling supports 2902, 2904, 2906, and 2908 to frame 2920 electrically couples conductor 2922 and 2924 respectively to conductor 2910 and 2912 each support.

Supports 2906 and 2908 support objects 2930 and 2940 respectively. Each support may support a plurality of objects as opposed to the single objects shown on supports 2906 and 2908. Each object includes a respective tag. In this implementation, objects 2930 and 2940 include tags 2932 and 2942 respectively. Each tag is mechanically coupled to its respective object. Each tag includes a first and a second terminal. Tag 2932 includes terminals 2934 and 2936 while tag 2942 includes terminals 2944 and 2946. Placing objects 2930 and 2940 on supports 2906 and 2908 electrically couples terminal 2934 and 2944 to conductor 2910 and terminals 2936 and 2946 to conductor 2912. While supports 2906 and 2908 are electrically coupled to frame 2920, conductor 2922 couples to conductors 2910 and terminals 2934 and 2944. Furthermore, conductor 2924 couples to conductors 2912 and terminals 2936 and 2936.

Signal generator 2954 provides a carrier to either conductor 2922 or 2924 (e.g., across conductors 2922 and 2924). The conductors transport the carrier to tags 2932 and 2942, which modulate the carrier in accordance with the information stored in each respective tag. Tags 2932 and 2942 may modulate the carrier simultaneously and/or at different times. A back-off period may be used to reduce the number of tags that simultaneously modulate the carrier as discussed above.

The conductors transport the modulated carrier to receiver 2952 of reader 2950. Receiver 2952 detects the indicia of the information provide in the modulated signal. The receiver, in combination with a processor and/or circuit (not shown), uses the indicia to recover the information from each tag regarding the object.

In one implementation, carrier generator 2954 is a module of reader 2950. In another implementation, system 3000 includes carrier generator 3054 in frame 3020. Carrier 2054 electrically couples to and impresses a carrier across conductors 3022 and 3024, which electrically couple, as described above, to the conductors of supports 2902, 2904, 2906, and 2908 and tags 2932 and 2942. Reader 3050 also electrically couples to conductors 3022 and 3024 and receiver 3052 receives indicia of the information stored in tags 2932 and 2942.

In an implementation, carrier generator couples to conductors 2910 and 2912 of any support to provide the carrier to tags 2932 and 2942. In an implementation, reader 3050 couples to conductors 2910 and 2912 of any support to receive the modulated carrier.

A reader may couple via a link to a network. In one implementation, reader 2050 couples to network 3050.

In one implementation, display system 3400 is similar to display system 2900 except that display system 3400 does not include a carrier generator. Reader 3450 includes receiver 3452 and transmitter 3454 for bidirectional communication with tags 2932 and 2942. Transmitter 3454 couples to conductors 2922 and 2924 to provide a signal to conductors 2922 and 2924 to send information to tags 2932 and 2942. Information may include an address, a status, a data, and/or a control signal. Receiver 3452 couples to conductors 2922 and 2924 to detect information from tags 2932 and 2942.

Transmitter 3454 and receiver 3452 may alternately couple to conductors 2922 and 2924 to transmit and receive information respectively.

Transmitter 3454 and receiver 3452 may provide energy to tags 2932 and 2942 (e.g., passive tags) to perform a function and/or communicate.

Reader 3450 individually addresses and communicates in a bidirectional manner with each tag. Bidirectional communication includes simultaneously transmission and reception by a tag and/or reader or non-overlapping transmission and reception where a first device transmits over conductors 2922 and 2924 while all other devices receive and the first device receives over conductors 2922 and 2924 while all one or more other devices transmit.

In another implementation of a system for identifying, tracking, monitoring, displaying, and/or storing objects, is implemented as a pegboard system. A pegboard system includes board 1300 (e.g., frame), hook 1500 (e.g., support), hook 1612 (e.g., support), product 1602, reader 1614, and a first conductor. A second conductor may be provided to complete a circuit between a reader and a tag or a plurality of tags. A circuit may also be provided through the first conductor and a ground connection common to other components such as a reader and a board.

A board supports hooks that support objects for storage and/or display. A board positions objects for inspection and removal. A board having hooks provides a position for restocking an object. A board positions hooks relative to each other. A board supports conductors. A board mechanically couples to hooks. A board electrically couples to hooks. Hooks electrically and/or mechanically coupled to conductors of a board. A board electrically couples to tags. For example, board 1300 includes a plurality of holes for mechanically coupling to and supporting hooks. Holes of a board may also be implemented as slots and grooves. A hole, slot and/or groove may partially or completely penetrate a board. In one implementation, a board has a first side 1302 and a second side 1304. A first side and a second side may be electrically separate. A support (e.g., hook) may mechanically couple to the first side and/or the second side. A support may electrically couple to a first side and/or a second side. A first side and/or a second side may be electrically coupled to a reader.

A hook mechanically couples to a board for supporting objects for storage, display and/or access. A hook mechanically couples to an object for storing and/or displaying the object. A hook may electrically couple to a side of the board. A hook may electrically couple to a reader and an object. For example, hook 1500 inserts into a hole of board 1300. Interference of board 1300 with hook 1500 mechanically couples hook 1500 to board 1300. Hook 1500 inserts into hole 1606 of product 1602. Interference of hook 1500 with at least a portion of the circumference of hole 1606 mechanically couples hook 1500 to product 1602. Similarly, hook 1612 inserts through a hole 1306 in board 1300 and hole 1604 of product 1602. Interference between board 1300 and product 1602 with hook 1612 mechanically couples hook 1612 to board 1300 and product 1602.

In an implementation, hook 1500 electrically couples to side 1304 of board 1300 which electrically couples to reader 1614. Hook 1612 electrically couples to side 1302 which electrically couples to reader 1614. Hook 1500 and hook 1612 further electrical couple to inner circumference of holes 1606 and 1604 respectively which electrically couple to tag 1616 by wires 1610 and 1608 respectively. Accordingly, a first conductor that includes hook 1500 and side 1304 of board 1300 electrically couples reader 1614 to tag 1616. A second conductor that includes hook 1612 and side 1302 of board 1300 electrically couple reader 1614 to tag 1616.

In an implementation, hook 1702 and 1704 mechanically couple to board 1706 and conductors 1708 and 1710 respectively through holes 1712 respectively. Hooks 1702 and 1704 electrically couple to conductor 1710 and 1708 respectively. Conductors 1708 and 1710 may electrically couple to a reader. Hooks 1702 and 1704 may electrically couple to a tag of an object as described above.

In another implementation, holes of board 1804 are electrically couple in a pattern for providing electrical coupling to hooks inserted through holes of board 1804. In one implementation, holes of board 1804 are electrically couple in such a manner that adjacent holes are electrically coupled to a different conductor. For example, holes 1806 and 1810 are couple to a first conductor while holes 1808 and 1812 are couple to a second conductor. Insertion of a first hook and a second hook through holes 1810 and 1812 respectively results in an electrical connection of the first hook to the first conductor and the second hook to the second conductor. Reader 1802 electrically couples to the first conductor and the second conductor. The first hook and the second hook may also electrically couple to an object thereby completing a circuit from a tag on the product to the reader.

A first hook and a second hook may mechanically couple, yet remain electrically separate. For example, hanger 1900 includes hook 1902 and hook 104 mechanically coupled by connector 1906. Connector 1906 electrically separates arms 1902 and 1904. Hook 1902 and 1904 mechanically couple to board 2008 through holes 2002. Hook 1902 and 1904 electrically couples to conductors 2006 and 2004 respectively. Hanger 1900 may mechanically couple to an object (not shown) while hooks 1902 and 1904 respectively electrically couple to a tag associated with the object (not shown). Conductors 2004 and 2006 may couple to a reader (not shown) thereby coupling the reader to the tags of a plurality of products electrically coupled to hanger 1900.

Conductors of a container may further operate as a support. A container may hold objects. A portion of the conductors of the container may contact and electrically couple to an object or a plurality of objects inside the container. A portion of the conductors of the container may mechanically and electrically couple to a frame. A container may removeably couple to a frame. In one implementation, container 3202 retains object 3204. Object 3204 includes a tag (not shown). Terminal 3206 and 3208 of object 3204 contact and electrically couple to a portion of conductors 3210 and 3212 respectively. A portion of conductors 3210 and 3212 mechanically and electrically couple to frame 3214.

A user may benefit from an apparatus (e.g., retrofit kit) and/or methods that prepare an existing container (e.g., cardboard box, file drawer, filing cabinet, literature holder, business card holder, lottery card shelves, phone card bin) to provide electrical connectivity from a reader to objects within the container. A retrofit kit, according to various aspects of the present invention, may provide electrical signals from a tag or plurality of tags associated with objects in/on the container to a reader. A reader may be fixedly coupled to the retrofit container or a portable reader may be temporarily coupled to a retrofit container to receive records from tags of objects in/on the retrofit container.

In an implementation, a retrofit kit includes a plurality of rails 2102 and a portable reader 2202. Rails 2102 fit over the edges of the container 2100 that support the hook portion of a hanging folder. The rails contact hanging folders (not shown) having a tag. Portions of the rails, 2108, 2110 are positioned external to the container to permit contact with reader 2202. Portions 2108 and 2110 of rails 2102 are exposed below lid coverage line 2106 to permit a reader to receive records from tags associated with files inside container 2100 without opening and/or removing a lid (not shown) of container 2100. Reader 2202 may also be placed atop rails 2102 to electrically couple with the tags of the hanging folders to receive records.

Rails 2102 may have a conductive portion and an insulator portion to separate the conductive portion of rail 2102 from a conductive container. A conductive portion may include metal tape, metal that mechanically couples to a container, conductive paint, and a conductive sticker that adheres to a surface of container 2100. Rail 2102 may couple to container 2100 in any conventional manner for example friction (e.g., clipping to, detent), sticking (e.g., glue, adhesive), and attaching (e.g., staple, brad, bolt).

An implementation of a retrofit kit may accommodate files and/or cards that do not have hooks for hanging. Document 2504 mechanically couples to at least two contacts 2502. Contacts 2502 electrically couple to one rail 2402 respectively. A tag (not shown) may be associated with document 2504 and electrically coupled to contacts 2502 such that the tag electrically couples through rails 2402 to reader 2202. Contacts 2502 and rails 2402 are positioned to provide a first conductor and a second conductor that are electrically separate and electrically couple the tag to reader 2202. A portion 2506 of rail 2402 may be positioned below a lid (not shown) that may cover container 2100 thereby permitting reader 2202 to contact rails 2402 without removing the lid.

A method for retrofitting a container according to various aspects of the present invention includes applying rails to a container, placing files having a respective tag into the container in such a manner as to contact the rails, contacting the reader to the rails, receiving a record from each file.

Containers equipped with a retrofit kit may be placed into a storage area that provides electrical contact to a reader. In one implementation, shelf 2602 stores containers 2100 retrofit with rails according to various aspects of the present invention. Rails from each container 2100 electrically couple in a suitable manner to permit a reader to receive records from tags in containers stored on shelf 2602. A directional device, as described above, may be coupled to each tag to ensure that each tag may communicate with the reader regardless of orientation of container 2100. Portions 2110 and 2108 of rails on containers 2100 may electrically couple to contact 2702 and 2704 respectively. Contacts 2702 and 2704 may electrically couple to all containers 2100 placed on shelf 2602 or separate contacts may be used to electrically couple to a portion of the containers 2100. A reader electrically couples to contacts 2702 and 2704 to electrically couple to the tags of the files in containers 2100.

A radio frequency (“RF”) identification (“ID”) reader and an RF ID tag may cooperate to provide information as to a status of a position of a door. A door may be in an opened state or a closed state. Information regarding a status of a position of a door (e.g., open, closed) may be important to a user.

An RF ID reader and an RF ID tag may be used to detect the position of a door by positioning the reader on one side of a door, positioning the tag on the other side of the door, and detecting an RF signal.

A quality of the RF signal detected by the RF ID reader and/or the RF ID tag may provide information as to the status of the position of the door. In one implementation, a door is the only entrance to an enclosure. The RF ID reader is positioned outside of the enclosure. The RF ID tag (e.g., active or passive) is positioned inside the enclosure. While the door is closed, the enclosure and the door block transmission and reception (e.g., communication) of RF signals between the RF ID reader and the RF ID tag. While the door is in a closed position, the RF ID reader does not detect an RF signal from the RF ID reader. Furthermore, when the door is closed, a passive RF ID tag does not receive the RF signal that provides energy for transmission, thus, the RF ID tag does not transmit. When the door is in an open position, the RF ID reader detects an RF signal from the RF ID tag. Furthermore, when the door is open, a passive RF ID tag receives the RF signal that provides energy and accordingly provides an RF signal to the RF ID reader which is detected by the RF ID reader through the open door.

In another implementation, the door partially blocks the RF signal and the RF ID reader detects the status of the position of the door, whether opened or closed, by detecting the strength of the RF signal. Signal strength may be detected in any manner for example, strength of radiation and detecting a pattern whose completeness depends on signal strength.

The foregoing description discusses preferred embodiments of the present invention, which may be changed or modified without departing from the scope of the present invention as defined in the claims. While for the sake of clarity of description, several specific embodiments of the invention have been described, the scope of the invention is intended to be measured by the claims as set forth below.

What is claimed is:

1. A system for displaying at least one provided object and for providing an information regarding each object, the system comprising:
a frame having a first conductor;
a support having a second conductor;
a reader; and
at least one tag, each tag having a respective first terminal, each tag mechanically coupled to a respective object of the at least one object, and each tag stores the information regarding the respective object to which the tag is coupled; wherein:
the support removeably couples to the frame;
the at least one object is removeably positioned on the support;
the reader electrically couples to at least one of the first conductor and the second conductor;
while the support is coupled to the frame, the second conductor electrically couples to the first conductor;
while the at least one object is positioned on the support:
the second conductor electrically couples to the first terminal of each tag;
each tag modulates in accordance with its respective information a carrier provided to at least one of the first conductor and the second conductor thereby producing a modulated carrier; and
the reader receives the modulated carrier thereby receiving the information from each tag respectively; and
the reader does not send information to any tag.

2. The system of claim 1 wherein:
the frame comprises a pegboard; and
the support comprises a hanger.

3. The system of claim 1 wherein:
the frame comprises a plurality of discrete mounting locations; and
the support mechanically mounts to the frame at one mounting location of the plurality of discrete mounting locations.

4. The system of claim 1 further comprising a carrier generator; wherein:
the frame further comprises a third conductor;
the support further comprises a fourth conductor;
the tag further comprises a second terminal;
the carrier generator provides the carrier;
the carrier generator provides a common to at least one of the third conductor and the fourth conductor;
while the support is coupled to the frame, the fourth conductor electrically couples to the second conductor;
while the at least one object is positioned on the support and the support is coupled to the frame:
the fourth conductor electrically couples to the second terminal of each tag.

5. The system of claim 1 wherein the information provided by each tag comprises a respective unique number.

6. The system of claim 1 further comprising a plurality of supports, wherein each one support comprises a second conductor respectively.

7. The system of claim 6 wherein any one support supports a plurality of objects.

8. A system for displaying at least one provided object and for providing an information regarding each object, the system comprising:
a frame having a first conductor;
a support having a second conductor;
a reader; and
at least one tag, each tag having a respective first terminal, each tag mechanically coupled to a respective object of the at least one object, and each tag stores the information regarding the respective object to which the tag is coupled; wherein:
the frame comprises a plurality of discrete mounting locations;
the support removeably couples to the frame at a discrete mounting location of the plurality of discrete mounting locations;
the at least one object is removeably positioned on the support;
the reader contacts and electrically couples to at least one of the first conductor and the second conductor;
while the support is coupled to the frame, the second conductor contacts and electrically couples to the first conductor;
while the at least one object is positioned on the support:
the second conductor contacts and electrically couples to the first terminal of each tag;
the reader bidirectionally communicates with each tag through at least one of the first conductor and the second conductor thereby receiving the information from each tag respectively.

9. The system of claim 8 wherein:
the frame comprises a pegboard; and
the support comprises a hanger.

10. The system of claim 9 wherein:
the plurality of discrete mounting locations comprises a plurality of holes; and
the hanger mechanically couples to the pegboard through at least one hole.

11. The system of claim 10 wherein:
a first portion of the plurality of holes are associated with the first conductor;
a second portion of the plurality of holes are associated with a second conductor; and
mechanically coupling the hanger to a hole of the first portion, electrically couples the hanger to the first conductor.

12. A system for holding at least one provided object and for providing an information regarding each held object, the system comprising:
a container that encloses the at least one object inside the container, the container having a first conductor;
a reader; and
at least one tag, each tag having a respective first terminal, each tag mechanically coupled to a respective object of the at least one object, and each tag stores the information regarding the respective object to which the tag is coupled; wherein:
the reader electrically couples to a first portion of the first conductor;
while the at least one object is enclosed inside the container:
a second portion of the first conductor contacts and electrically couples to the first terminal of each tag respectively of each object;
each tag modulates a carrier provided to the first conductor in accordance with its respective information thereby producing a modulated carrier; and
the reader receives the modulated carrier thereby receiving the information from each tag respectively; and
the reader does not send information to any tag.

13. The system of claim 12 wherein the container mechanically positions the at least one object in such a manner that the first terminal of each tag contacts and electrically couples to the second portion of the first conductor.

14. The system of claim 12 wherein the container comprises an opening for dispensing the at least one object from the container.

15. The system of claim 12 wherein the container comprises an opening for inserting the at least one object into the container.

16. The system of claim 12 wherein the first portion of the first conductor is positioned on an outside of the container.

17. The system of claim 12 wherein a second portion of the first conductor is positioned on an inside of the container.
